(19) United States
(12) Patent Application Publication
(10) Pub. No.: US 2026/0286097 A1
(43) Pub. Date: Sep. 24, 2026

(54) MANGANESE POLYMERS AND CATALYSTS FOR PLASTIC ARTICLES

(71) Applicant: Plastipak Packaging, Inc., Plymouth, MI (US)

(72) Inventors: Miguel Vieira, Funchal (PT); Aditi Bhattacharyya Ghosh, Wijnegem (BE)

(21) Appl. No.: 19/472,974

(22) PCT Filed: Apr. 5, 2024
(86) PCT No.: PCT/US2024/023303

§ 371 Date: Oct. 6, 2025

Related U.S. Application Data
(60) Provisional application No. 63/457,927, filed on Apr. 7, 2023.

(51) Int. Cl. C08K 5/00; B01J 31/22; B32B 27/08; B32B 27/18; B32B 27/36; B65D 1/02; C08L 67/02

(52) U.S. Cl. CPC C08K 5/0091; B01J 31/223; B32B 27/08; B32B 27/18; B32B 27/36; B65D 1/0215; C08L 67/02; B01J 2231/70; B01J 2531/72; B32B 2250/244; B32B 2307/7244; B32B 2439/60; C08L 2201/14; C08L 2203/10; C08L 2207/20

(57) ABSTRACT

A barrier for polymer or plastic molding, such as injection molding, includes a manganese (Mn) catalyst and an oxygen barrier. In embodiments, the Mn catalyst may comprise from 50 ppm Mn to 350 ppm Mn. In embodiments the oxygen barrier may include MXD6. Such barriers may be included with a polymer to form a composition used in a molding (e.g., injection) process. In embodiments, a barrier includes a transition metal catalyst, an organic compound, and a radical initiator. Plastic preforms and containers that are molded with such barriers/compositions are also disclosed.

### CROSS-REFERENCE TO RELATED APPLICATIONS

This application claims the benefit of priority to United States Provisional Application Ser. No. 63/457,927, filed Apr. 7, 2023, which is fully incorporated herein by reference.

### TECHNICAL FIELD

The present disclosure generally relates to barriers or barrier materials that may be used in connection with plastic articles, such as plastic preforms and containers, and plastic preforms and containers that include barriers or barrier materials.

### BACKGROUND

Plastic containers are used to hold a variety of contents. Plastic preforms and containers may be comprised of various polymers and may have varying degrees of permeability to oxygen or other molecules. It can be desirable to provide plastic preforms and containers that have barrier properties that may reduce or eliminate certain permeation or levels of permeation. Such barrier compounds/materials may affect or improve, among other things, a molecular permeation associated with a preform or container.

By way of additional background, U.S. patent application Ser. No. 17/432,649, filed Aug. 20, 2021, is incorporated herein by reference.

### SUMMARY

A barrier for polymer or plastic molding, such as injection molding, includes a manganese (Mn) catalyst and an oxygen barrier. In embodiments, the Mn catalyst may comprise from 50 ppm Mn to 350 ppm Mn. In embodiments, the barrier or associated article may be devoid of cobalt and/or may comprise a copolymer of PET blended with manganese may comprise from about 2.5 ppm Mn to about 350 ppm Mn, from about 50 ppm to about 350 ppm Mn, from about 100 ppm Mn to about 300 Mn, from about 100 ppm Mn to about 350 ppm Mn, from about 200 ppm Mn to about 300 ppm Mn, or from about 200 ppm Mn to about 350 ppm Mn. In embodiments the oxygen barrier may include MXD6. Such barriers may be included with a polymer to form a composition used in a molding (e.g., injection) process. In embodiments, a barrier includes a transition metal catalyst, an organic compound, and a radical initiator. Plastic preforms and containers that are molded with such barriers/compositions are also disclosed.

### BRIEF DESCRIPTION OF THE DRAWINGS

Embodiments of the disclosure will now be described, by way of example, with reference to the accompanying drawings, wherein:

FIG. 1 generally illustrates a side cross-sectional view of an embodiment of a monolayer preform according to aspects or teachings of the present disclosure;

FIG. 2 generally illustrates an embodiment of a multilayer preform according to aspects or teachings of the present disclosure;

FIG. 3 generally depicts a graph of a Mn catalyst shown in comparison with a cobalt catalyst with a nylon based barrier formulation;

FIG. 4 generally depicts a graph of embodiments with monolayer recipes with Mn polymers, and oxygen ingress over time;

FIG. 5 generally illustrate embodiments of bottles having nylon based and nylon free sacrificial polymers;

FIG. 6 generally depicts a graph of oxygen transmission over time associated with embodiments of virgin PET (VPET) and RPET;

FIG. 7 generally depicts a graph of oxygen transmission over time associated with embodiments of RPET that is Mn based versus RPET that is cobalt based;

FIG. 8 generally illustrates oxygen transmission over time associated with a monolayer embodiment of the present disclosure;

FIG. 9 generally illustrates a plastic bottle of the type associated with FIG. 8;

FIG. 10 generally illustrates oxygen transmission over time associated with a multilayer embodiment of the present disclosure; and

FIG. 11 generally illustrates a plastic bottle of the type associated with FIG. 10.

### DETAILED DESCRIPTION

This disclosure involves barriers (or barrier compositions) for plastic articles, including plastic preforms and/or plastic containers.

For a period of time, cobalt was considered to be the only catalyst successful for a PET-based oxygen scavenger. The disclosure involves, inter alia, the substitution or replacement of cobalt catalysts with manganese based catalysts. An aspect of this disclosure involves, among other things, manganese (Mn) catalysts that may be used in connection with oxygen barriers (or barrier compositions) associated with plastic preforms and containers.

In connection with the disclosure, copolymers—comprising a polymer (e.g., polyethylene terephthalate (PET))—may be blended with manganese coordination polymers. Manganese coordination polymers may, for example and without limitation, comprise a manganese complex with monoacidic and diacidic ligands. Although, other polymers (which may include PET) involving manganese/manganese blends are also envisioned by the disclosure.

With embodiments, recycled contend—e.g., post-consumer recycled (PCR) content—may be included in various articles that include a manganese based catalyst. The recycled content (e.g., recycled PET (RPET)) may come from a recycling stream. However, for acceptable commercial clarity (such as in view of industry standards, such as ASTM standards), the article will commonly need to avoid presenting an unacceptable level of yellowing or haziness. For example, an embodiment a multilayer article (e.g. preform) having a 15% core layer which comprises about 5% by weight 5% nylon-free scavenger, up to 350 ppm Mn in a manganese based catalyst, and PET would have a commercially acceptable level of yellowing or haziness.

In embodiments, the included catalyst may include a number of parts per million (ppm) of Manganese, and the amount of Manganese may be sufficient to maintain a necessary level of scavenging (without excessive haze), while yet not being so high an amount so as to unacceptably impair or impede processing (e.g., so as not to invoke screw slippage).

The following examples are for illustration purposes only and are not intended to limit the scope of the disclosure or claims. With embodiments, a copolymer of PET blended with manganese may comprise from about 2.5 ppm Mn to about 350 ppm Mn, from about 50 ppm to about 350 ppm Mn, from about 100 ppm Mn to about 300 Mn, from about 100 ppm Mn to about 350 ppm Mn, from about 200 ppm Mn to about 300 ppm Mn, or from about 200 ppm Mn to about 350 ppm Mn.

In an embodiment, a multi-layer article (e.g., preform) may include 15% of core layer, up to 350 ppm Mn in a manganese based catalyst, 5% nylon-free scavenger, and RPET. Such a combination may further have a haze factor (under ASTM standards) of less than 5%, but preferably of about 3% or less.

In an embodiment, a monolayer article (e.g., preform) may have a 0.75% nylon free scavenger (which can be increased for additional shelf life, that may preferably reach at least 180 days), up to 150 ppm manganese, and RPET. With such an article, up to 5% haze may be deemed to be acceptable.

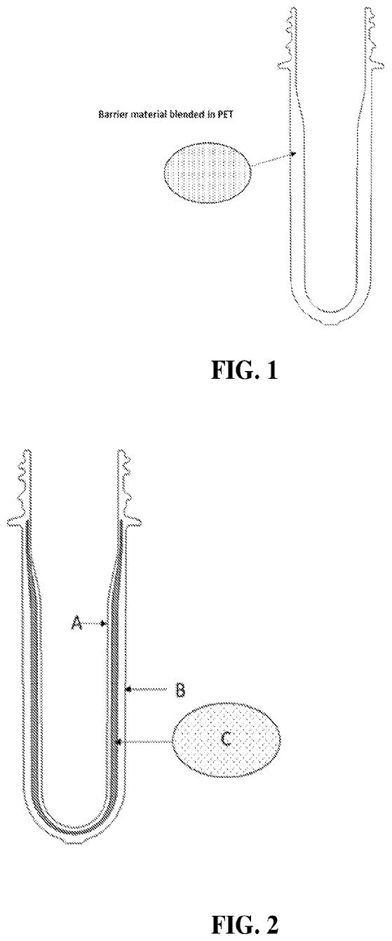

FIG. 1 generally illustrates an embodiment of a monolayer preform. The monolayer structure may, for example, comprise a barrier material blended in PET. Such an embodiment may, without limitation, involve 50-300 ppm of MN, or 50 -350 ppm of MN, in the overall preform.

FIG. 2 generally illustrates an embodiment of a multilayer preform. While the disclosure is not limited to a specific number of layers, the illustrated embodiment comprises a three layer preform.

As generally illustrated in the above embodiment, in cross section, a multilayer preform may include an inner polymer (e.g., PET) layer (A), an outer polymer (e.g., PET) layer (B), and an intermediate B-layer or barrier layer (C). As generally illustrated, in embodiments the multilayers may predominantly be disposed below the neck flange. The barrier layer may, for example, comprise a barrier material blended in PET. Such an embodiment may, for example and without limitation, comprise 5%-15%, by weight, barrier layer (C) with 50 -350 ppm of MN; or 2.5 ppm (5% B-layer with 50 ppm MN)—52.5 ppm MN (15% B-layer with 350 ppm MN)—in the overall preform.

The use of a manganese based catalyst such as disclosed herein, among other things, may maintain or increase desired shelf life for contents, may incorporate RPET, may be included with articles that are readily recyclable (in the stream), and may not undesirably effect look/color of associated articles.

As part of the inventive concepts, barrier compositions have been made or developed that comprise of a composition of manganese and polymers or copolymers having certain ratios.

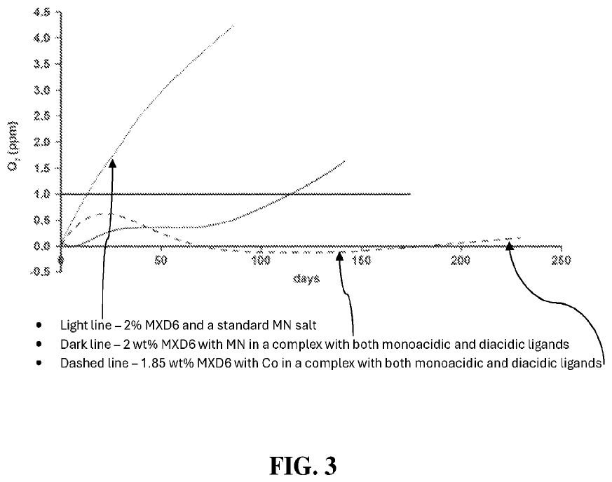

As generally illustrated in FIG. 3, a Mn catalyst is shown in comparison with a cobalt catalyst with a nylon based barrier formulation. With this embodiment of the disclosure, oxygen concentrations in an article (i.e., a bottle) are illustrated in connection with a bottle with 2% MXD6 and a standard Mn salt, 2 wt % MXD6 with Mn in a complex with both monoacidic and diacidic ligands, 1.85 wt % MXD6 with Co in a complex with both monoacidic and diacidic ligands.

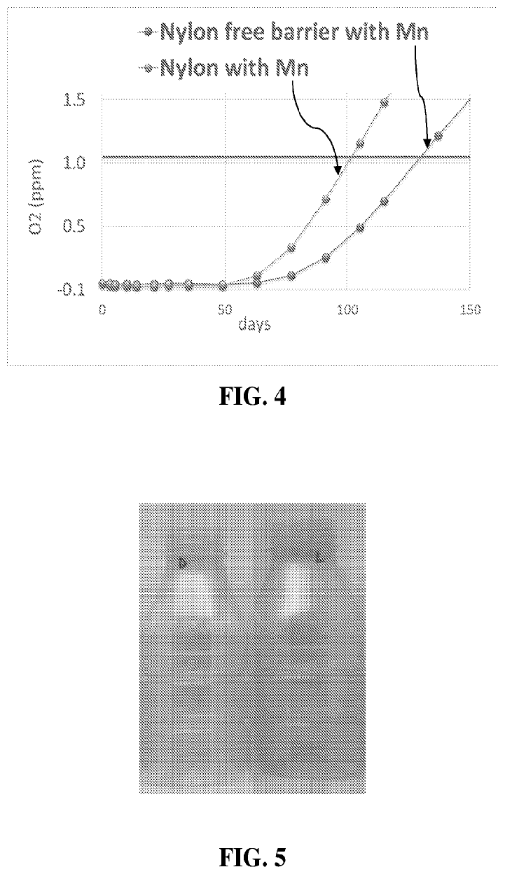

Embodiments of the present disclosure may demonstrate compatibility with nylon based and nylon free sacrificial polymers. For example and without limitation, the graph of FIG. 4, and associated bottles of FIG. 5, generally illustrates embodiments with monolayer recipes with Mn polymers, and oxygen (in ppm) ingress over time (days), such as with respect to a sealed container. With respect to FIG. 4, a divergence in O2 (ppm) comparative ingress is more pronounced after about 50 days. The oxygen ingress thereafter is shown to be increasing at a faster rate with respect to the container having nylon with Mn (e.g., the container designated “L” in FIG. 5) than the container that contains or comprises a nylon free scavenger with Mn (e.g., the container designated “D” in FIG. 5). As illustrated, the container that included the nylon free scavenger with Mn demonstrated a comparatively longer “shelf life” resistance to oxygen ingress than the container with nylon and Mn.

Additionally, embodiments of the disclosure may provide good processability and stability at elevated/high temperatures, for example and without limitation, at about 270° C. or above.

For example and without limitation, embodiments of multilayer bottles may have 15% multilayer (with 5% nylon free sacrificial polymer, 300 ppm Mn, and PET), with 100% RH inside. With some embodiments, the MN content in the polymer may range from, for example and without limitation, about 1% to about 5%, or from about 1% to about 2% of the polymer (by weight).

For example and without limitation other embodiments may involve monolayer bottles, which may have different ppm of Mn—e.g., 50 ppm, 100 ppm, 150 ppm, or 200 ppm. Such embodiments may include, for example and without limitation, 0.75% nylon free scavenger plus MN.

Embodiments of the present disclosure may also exhibit good/acceptable compatibility with RPET.

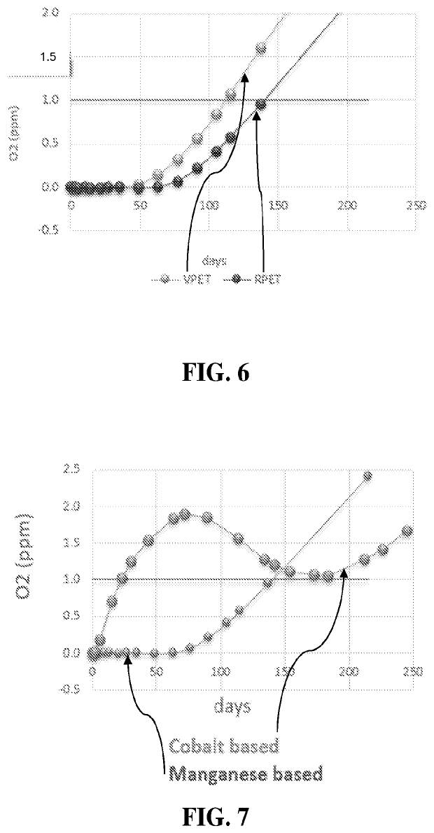

FIG. 6 generally illustrates oxygen transmission over time associated with embodiments of virgin PET (VPET) and RPET involving 200 ppm Mn and 0.75% nylon free SP.

FIG. 7 generally illustrates oxygen transmission over time associated with embodiments of RPET that is Mn based versus RPET that is cobalt based.

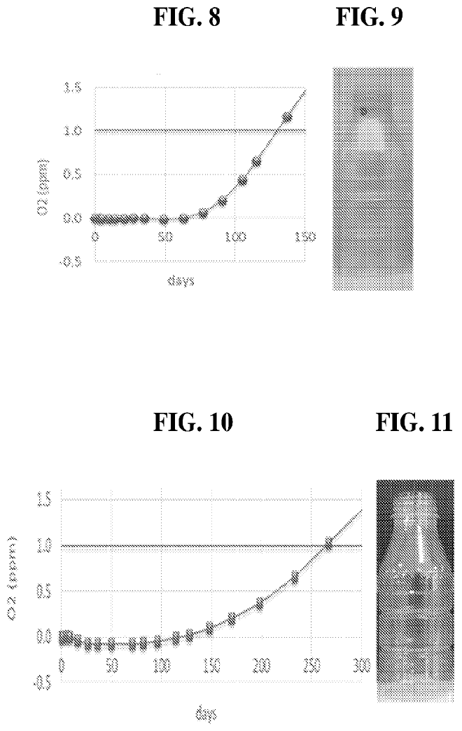

FIGS. 8 and 10 generally illustrate oxygen transmission (e.g., barrier performance) associated with monolayer embodiment (FIG. 8) and a multilayer embodiment (FIG. 10), along with illustrations of associated plastic bottles/containers (FIGS. 9 and 11, respectively). Mn concentration in the overall container, less barrier utilization in total preform, is 350 ppm for the monolayer embodiment, and 52.5 ppm for the multilayer embodiment.

It is noted that articles (e.g., bottles) including Mn polymers can achieve 0 ppm oxygen intake/ingress with both monolayer and multilayer embodiments over a significant period of time. Common industry requirements may involve ranges, which may further vary by product content category. For example, juices may involve transmission limitation requirements for about a three-month time period, while wine may have transmission limitation requirements for a period of about 24 months. It is noted that with embodiments of the present disclosure that to modify a transmission/barrier rate, adjustments may be made with respect to the quantity of polymer and/or associated sacrificial polymer.

With embodiments of the disclosure different manganese coordination polymers may be used as a suitable oxygen scavenger or scavenging material. For example and without limitation, in an embodiment, a highly-active Mn-based oxygen barrier was provided with 2% MXD6. Additionally, there can be a difference in activity between Mn neodecanoate and Mn coordination polymer on a low concentration with 1.85% MXD6. Certain custom or tailor-made manganese based catalysts may be prepared and used in place of cobalt with oxygen scavengers, and may particularly be used in connection with plastic (e.g., PET) injection molding.

A further aspect of the present disclosure involves, among other things, radical initiators that may be used in connection with oxygen barriers associated with plastic preforms and/or containers.

Oxygen as a diradicalar molecule typically only reacts with organic compounds through single-electron oxidations. In order for oxygen to be taken up by a sacrificial polymer in an oxygen scavenger system, there commonly first needs to be organic radicals present. Such radicals are usually produced at PET processing temperatures, but may, for example and without limitation, also be generated by photo-initiation, electrobeam, or microwave irradiation. Such types of treatment may be beneficial for a delayed initial phase, for instance, to control the start of a scavenging reaction.

In other embodiments, certain additives may be used to increase the initiation rate by indirect radical generation, such as at the PET processing step. As such, organic compounds with decomposition temperatures below PET processing temperatures may degrade in a radicalar mechanism at much higher rates than the main sacrificial compound. The oxygen scavenging capacity this carries can cause a short but intense oxygen scavenging rate increase in the packaging as the container is filled. This can encompass mainly unsaturated compounds, such as squalene, unsaturated fatty acids, and polybutadiene.

With embodiments, Mn copolymers may be self-initiating, with activation associated with various carrier composition. Although, compositions associated with the present disclosure may involve radical initiators. Embodiments may be Mn based and may involve a polymer matrix with something that activates or initiates oxygen scavenging capability.

With embodiments of the present disclosure certain thermal radical initiators can be used to not only cause a faster initiation, but may also increase shelf life of a container and its contents by a significant amount, even without any oxygen scavenging capacity on its own or external triggers. For example and without limitation, radical initiators may comprise azo compounds or peroxides. With embodiments, such a reaction may only be active during the molding (e.g., injection molding) phase. However, the increased initiation can provide for a higher propagation rate, such that the effect of radical termination may be reduced by limiting the effect of antioxidative additives and yet provide a higher reactive oxygen species content.

Such radical initiators may, for example and without limitation, be added to an oxygen barrier that may comprise or consist of a transition metal catalyst (e.g., Co, Mn, Fe, or Cu) and an organic compound (e.g., MXD6, MXBI, Polybutadiene, Polysqualene, or polytetrahydrofuran).

In an embodiment, a radical initiator of the type taught by this disclosure may be used in combination with a transition metal catalyst (such as manganese, which is compatible with PET), and further may include an organic compound, such as MXD6.

The disclosure includes, without limitation, the following embodiments:
1. A barrier for molding a polymer, the barrier comprising: a manganese (Mn) catalyst comprising from about 2.5 ppm Mn to about 350 ppm Mn, from about 50 ppm to about 350 ppm Mn, from about 100 ppm Mn to about 300 Mn, from about 100 ppm Mn to about 350 ppm Mn, from about 200 ppm Mn to about 300 ppm Mn, or from about 200 ppm Mn to about 350 ppm Mn; and an oxygen barrier.
2. The barrier of embodiment 1, wherein the oxygen barrier comprises MXD6.
3. The barrier according to any of the preceding embodiments, wherein the oxygen barrier comprises an oxygen scavenger.
4. The barrier according to any of the preceding embodiments, wherein the oxygen barrier is devoid of cobalt.
5. A composition comprising a polymer, and a barrier as disclosed in embodiment 1, the barrier introduced into the polymer.
6. The composition of embodiment 5, wherein the polymer is polyethylene terephthalate (PET).
7. The composition of embodiment 5, wherein the oxygen barrier comprises about 2 w t% MXD6.
8. The composition of embodiment 5, wherein the polymer comprises polypropylene (PP).
9. The composition of embodiment 5, wherein the polymer comprises polyethylene (PE).
10. An article that is injection molded from a composition comprising a polymer and a barrier according to embodiment 1.
11. The article of embodiment 10, wherein the article comprises a preform or container.
12. The article of embodiment 11, wherein the article is a multilayer article, includes a core layer of at least 15% by weight having up to 350 ppm Mn in a Mn based catalyst, 5% by weight nylon-free scavenger, and RPET.
13. The article according to any of the preceding embodiments, wherein the article has a haze factor of less than 5%.
14. The article according to any of the preceding embodiments, wherein the article has a haze factor of about 3% or less.
15. A barrier for plastic molding, the barrier comprising: a transition metal catalyst comprising from 50 ppm Mn to 350 ppm Mn; an organic compound; and a radical initiator.
16. A copolymer comprising: polyethylene terephthalate (PET); manganese (Mn) comprising from about 2.5 ppm Mn to about 350 ppm Mn, from about 50 ppm to about 350 ppm Mn, from about 100 ppm Mn to about 300 Mn, from about 100 ppm Mn to about 350 ppm Mn, from about 200 ppm Mn to about 300 ppm Mn, or from about 200 ppm Mn to about 350 ppm Mn; and an oxygen barrier.
17. A multilayer article, comprising: a catalyst including a range of Mn from about 2.5 ppm Mn to about 350 ppm Mn, from about 50 ppm to about 350 ppm Mn, from about 100 ppm Mn to about 300 Mn, from about 100 ppm Mn to about 350 ppm Mn, from about 200 ppm Mn to about 300 ppm Mn, or from about 200 ppm Mn to about 350 ppm Mn; a nylon-free scavenger; and PET and/or recycled PET (RPET).
18. The multilayer article according to any of the preceding embodiments, wherein the range of Mn is in a middle layer.
19. The multilayer article according to any of the preceding embodiments, having 5%, by weight, of nylon free sacrificial polymer, and at least about 300 ppm Mn.
20. A multilayer container, comprising: a neck portion, and a body portion; wherein the body portion comprises an inner polymer layer comprising PET, an intermediate layer of at least 15% by weight of the container, and an outer polymer layer; wherein the intermediate layer comprises a catalyst including a range of Mn a catalyst including (i) a range of Mn from about 2.5 ppm Mn to about 350 ppm Mn, from about 50 ppm to about 350 ppm Mn, from about 100 ppm Mn to about 300 Mn, from about 100 ppm Mn to about 350 ppm Mn, from about 200 ppm Mn to about 300 ppm Mn, or from about 200 ppm Mn to about 350 ppm Mn, (ii) a nylon-free oxygen scavenger comprising at least 5% by weight of the intermediate layer, and (iii) PET comprising at least some portion of recycled PET (RPET); and wherein the container has a haze factor of less than 5% and a sealed container has an oxygen ingress of about 0 ppm for at least 50 days.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such elements. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While examples of dimensions of certain components may be described herein, such dimensions are provided as non-limiting examples and the components may have other dimensions.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

What is claimed is:

1. A barrier for molding a polymer, the barrier comprising:
a manganese (Mn) catalyst comprising from 50 ppm Mn to 350 ppm Mn; and
an oxygen barrier.

2. The barrier of claim 1, wherein the oxygen barrier comprises MXD6.

3. The barrier of claim 1, wherein the oxygen barrier comprises an oxygen scavenger.

4. The barrier of claim 1, wherein the oxygen barrier is devoid of cobalt.

5. A composition comprising a polymer, and a barrier as disclosed in claim 1, the barrier introduced into the polymer.

6. The composition of claim 5, wherein the polymer is polyethylene terephthalate (PET).

7. The composition of claim 5, wherein the oxygen barrier comprises about 2 wt % MXD6.

8. The composition of claim 5, wherein the polymer comprises polypropylene (PP).

9. The composition of claim 5, wherein the polymer comprises polyethylene (PE).

10. An article that is injection molded from a composition comprising a polymer and a barrier according to claim 1.

11. The article of claim 10, wherein the article comprises a preform or container.

12. The article of claim 11, wherein the article is a multilayer article, includes a core layer of at least 15% by weight having up to 350 ppm Mn in a Mn based catalyst, 5% by weight nylon-free scavenger, and RPET.

13. The article of claim 12, wherein the article has a haze factor of less than 5%.

14. The article of claim 12, wherein the article has a haze factor of about 3% or less.

15. A barrier for plastic molding, the barrier comprising:
a transition metal catalyst comprising from 50 ppm Mn to 350 ppm Mn;
an organic compound; and
a radical initiator.

16. A copolymer, comprising:
polyethylene terephthalate (PET);
manganese (Mn) comprising from 50 ppm Mn to 350 ppm Mn; and
an oxygen barrier.

17. A multilayer article, comprising:
a catalyst including a range of Mn from 2.5 ppm Mn to 350 ppm Mn;
a nylon-free scavenger; and
PET and/or recycled PET (RPET).

18. The multilayer article of claim 17, wherein the range of Mn is in a middle layer.

19. The multilayer article of claim 17, having 5%, by weight, of nylon free sacrificial polymer, and at least about 300 ppm Mn.

20. A multilayer container, comprising:
a neck portion, and
a body portion, the body portion comprising:
an inner polymer layer comprising PET;
an intermediate layer of at least 15% by weight of the container, comprising:
a catalyst including a range of Mn from 50 ppm Mn to 350 ppm Mn;
a nylon-free oxygen scavenger comprising at least 5% by weight of the intermediate layer; and
PET comprising at least some portion of recycled PET (RPET); and
an outer polymer layer comprising PET;
wherein the container has a haze factor of less than 5% and a sealed container has an oxygen ingress of about 0 ppm for at least 50 days.
